(19) United States
(12) Patent Application Publication
(10) Pub. No.: US 2026/0112918 A1
(43) Pub. Date: Apr. 23, 2026

(54) LARGE SCALE DATA GATHERING FOR GRID CONTROL BACKGROUND OF THE INVENTION

(71) Applicant: HITACHI, Ltd., Tokyo (JP)

(72) Inventors: Natsuhiko FUTAMURA, Santa Clara, CA (US); Panitarn CHONGFUANGPRINYA, San Jose, CA (US); Bo YANG, Santa Clara, CA (US); Yanzhu YE, San Jose, CA (US); Anthony HOANG, Sunnyvale, CA (US); Yoshihisa OKAMOTO, San Jose, CA (US)

(21) Appl. No.: 18/921,180

(22) Filed: Oct. 21, 2024

(51) Int. Cl. H02J 13/00; G06F 16/901

(52) U.S. Cl. CPC H02J 13/13; G06F 16/9027

(57) ABSTRACT

Systems and methods use a scalable cloud computing platform combined with an AI-based grid control process to facilitate collection of data from a large number of DERs. The data is organized into multiple time series with different resolutions required for grid control. A hierarchical tree structure facilitates efficient data aggregation and control signal generation, enhancing the system's capacity to manage at least 100,000 edge devices, theoretically scaling up to millions of edge devices. Embodiments optimize data collection by allowing minor delays, improving the overall efficiency and resource utilization of the system.

### BACKGROUND OF THE INVENTION

### BACKGROUND

### Field

The present disclosure is generally directed to grid control systems and methods, and more specifically, to scalable data gathering and grid control systems and methods.

### Related Art

Utilities and aggregators face operational challenges, such as overvoltage, due to the increasing integration of distributed energy resources (DERs), particularly behind-the-meter solar and edge devices, into the grid. Existing enterprise systems, like advanced distribution management systems (ADMS) and distributed energy resources management systems (DERMs), are not designed to effectively communicate, coordinate, and control these edge devices. This lack of data exchange and coordination among devices leads to sub-optimal operational performance.

One approach employs a behind-the-meter device visualization method and computing system based on the End-to-end Solar Energy Optimization Platform (e-SEOP) project. This method aims to improve performance and provide an optimal user experience during real-time operation, focusing on the visualization and prioritization of the condition and status of behind-the-meter devices. However, it lacks a method for scalability and large-scale implementation from a communication standpoint.

Another approach for system-wide DER management in the distribution grid provides only a high-level structure of DER management, resembling a tree-branch. This method does not address the scalability required for large-scale implementation from a communication perspective.

Yet another approach attempts to achieve scalability by using interoperable and cost-effective means to integrate a high penetration of DERs. However, this method has only been able to reach the level of 10,000 DERs in simulations.

Another method uses the Southern California Edison (SCE) model, simulating 10,000 DERs on an actual feeder and grouping them within similar zones to facilitate DERMS operations. Nonetheless, this approach acknowledges that developing a scalable architecture for controlling large-scale DERs remains a significant technological barrier.

Certain existing works address the problem of large-scale (10-100 million) DER penetration in the industry without fully resolving the issue. These works introduce the concept of Autonomous Energy Grids (AEGs), which are multilayer, hierarchical, and cellular-structured electric grids with control systems. AEGs are supported by a scalable, reconfigurable, and self-organizing information and control infrastructure. Control is achieved through hierarchical cells, starting from individual controllable technologies. However, this concept has only been tested on a small-scale feeder with more than 100 controllable assets in the lab, and real-world scalability is limited to a small community and a commercial site.

Implementing large-scale data gathering for over 100,000 devices remains a challenge. Therefore, what is needed are systems and methods that efficiently collect, process, and manage data from a vast number of DERs to facilitate effective grid control and ensure optimal operational performance on a large scale.

### SUMMARY

Embodiments herein facilitate large-scale data gathering and grid control methods, designed to collect data from a vast number of DERs and compile into multiple time series data with varying time resolutions needed for grid control. Unlike the data gathering limitations of existing platforms, various embodiments achieve a data gathering capacity of 100,000 or more edge devices for utility-scale deployment, with scalability for even higher numbers of edge devices. In operation, a large number of DERs periodically send data to a control platform, which analyzes DERs data and sends control signal back to the DERs. The DERs may be geographically widespread, e.g., covering an entire city. The data may be compiled in many ways depending on controls performed: some control requires fine resolution data from a small number of DERs, while others need coarse-resolution data from many DERs. Some implementations comprise organizing a set of time series data in a hierarchical manner, such as a tree structure. The application of an efficient parallel tree accumulation process enables fast computation, particularly advantageous when the tree is unbalanced.

Optimization of data collection by strategically allowing minor delays, eliminates previously existing dependencies in the data aggregation process across the network. This facilitates concurrent evaluation of data aggregations network-wide, substantially enhancing the efficiency of the execution process and leading to a significantly more resource-efficient system capable of managing large-scale data analysis and control for DERs using minimal computing resources.

In some aspects of the disclosure, a method for scalable data gathering and grid control comprises: receiving, at a child node that represents a leaf in a data tree, which includes a hierarchical tree structure, first time series data from DERs that represent a smallest sub-region of the data tree; until a root of the data tree comprises aggregated data, iteratively receiving, at nodes where all children nodes already have aggregated time series, i-th time series data that represents aggregated data of (i−1)-th or less data from the plurality of child nodes; iteratively updating the aggregated time series data at an update frequency that is greater than that of the plurality of child nodes; and in response to a controller generating control signals from updated data, using the control signals to control at least some of the plurality of child nodes. The updating may comprise excluding a latest received data to facilitate a network-wide data aggregation process, and cause a delay in data processing that eliminates a dependency in the network-wide data aggregation process.

In some aspects, the method further comprises using a parallel tree accumulation process, which may reduce a worst-case execution speed regardless of a tree height, to increase a computation performance in an unbalanced tree structure. The controller, prior to receiving new data, may analyze first time series data and communicates the control signals to the DERs based on a predefined control rule. And the time resolution of time series data at each node may be equal or greater than the resolution of the time series data at its child nodes.

In some aspects, the method further comprises using a message passing to communicate time series data between nodes, the message passing using at least one of Message Passing Interface Chameleon, Open Message Passing Interface, or Parallel Virtual Machine. In some aspects, in data reduction process, child nodes reduce a resolution of the time series data and communicate coarser data to the parent node, thereby reduce an amount of data communicated from receive children nodes to a parent node.

Control signals may be generated based on the updated time series data to mitigate at least one of an overvoltage, undervoltage, overfrequency, or underfrequency condition in a grid. In some aspects, the update frequency may be adjusted based on a real-time operational requirement of the grid, and each node may comprise a processing unit that generates a control signal.

In some aspects, the techniques described herein relate to a non-transitory computer-readable medium for storing instructions for executing a process, the instructions comprising: receiving, at a child node that represents a leaf in a data tree, which includes a hierarchical tree structure, first time series data from distributed energy resources (DERs), the DERs representing a smallest sub-region of the data tree; until a root of the data tree comprises aggregated data, iteratively receiving, at nodes where all children nodes already have aggregated time series, i-th time series data that represents aggregated data of (i-1)-th or less data from the plurality of child nodes; iteratively updating the aggregated time series data at an update frequency that is greater than that of the plurality of child nodes; and in response to a controller generating control signals from updated data, using the control signals to control at least some of the plurality of child nodes.

Aspects of the present disclosure can involve a system, which can involve means for receiving, at a child node that represents a leaf in a data tree, which includes a hierarchical tree structure, first time series data from DERs that represent a smallest sub-region of the data tree; receiving, at a parent node, second time series data that represents aggregated data from a plurality of child nodes; iteratively, at nodes where all children nodes already have aggregated time series, further aggregated time series data is received from the plurality of child nodes, until all nodes in the tree have aggregated time series data; the aggregated time series data are iteratively updated at an update frequency greater than that the plurality of child nodes; and means for using the control signals to control at least some of the plurality of child nodes, in response to a controller generating control signals from updated data. The updating may be performed by means for excluding a latest received data to facilitate a network-wide data aggregation process, and cause a delay in data processing that eliminates a dependency in the network-wide data aggregation process.

### BRIEF DESCRIPTION OF DRAWINGS

FIG. 1 is an example of a power distribution network according to various embodiments of the present disclosure.

FIG. 2 is an exemplary tree structure for controlling various zones shown in FIG. 1.

FIG. 3 illustrates a control method using a tree structure according to various embodiments of the present disclosure.

FIG. 4 depicts exemplary sample time series data that nodes of a control tree collect according to various embodiments of the present disclosure.

FIG. 5 illustrates how a naïve method computes controls for a well-balanced tree according to various embodiments of the present disclosure.

FIG. 6 illustrates how a control tree node computes a set of time series data from DERs according to various embodiments of the present disclosure.

FIG. 7 and FIG. 8 illustrate a naïve update for unbalanced trees according to various embodiments of the present disclosure.

FIG. 9 and FIG. 10 illustrate details of parallel tree accumulation algorithm's operation on an unbalanced tree according to various embodiments of the present disclosure.

FIG. 11 illustrates how to update multiple interdependent time series simultaneously, according to various embodiments of the present disclosure.

FIG. 12 illustrates how nodes in the tree are updated using an “update the one slot older” rule according to various embodiments of the present disclosure.

FIG. 13 is a flowchart illustrating an exemplary process for scalable data gathering and grid control in accordance with various embodiments of the present disclosure.

FIG. 14 illustrates an example computing environment comprising an example computer device according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

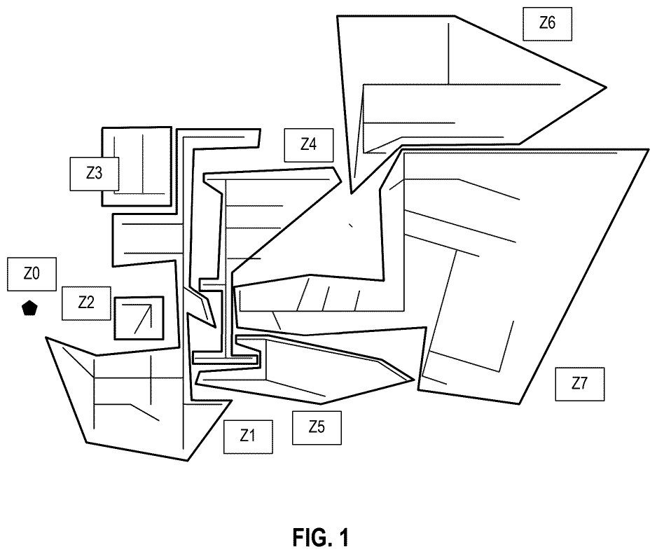

FIG. 1 is an example of a power distribution network according to various embodiments of the present disclosure. The network is subdivided into seven smaller zones with each section performing control operations within its own section. These smaller zones can be combined for other controls that involve more DERs in larger regions. It is desirable to overcome the data gathering limitations of such platforms and achieve a data gathering capacity of 100,000 or more edge devices for utility-scale deployment, with scalability for even higher numbers of edge devices. To accomplish this, in various embodiments, a large number of DERs periodically send data to a control platform, which analyzes DERs data and sends control signal back to the DERs. The DERs may be geographically widespread, e.g., covering an entire city. The data may be compiled in various ways depending on controls performed: some control requires fine resolution data from a small number of DERs, while others need coarse-resolution data from many DERs.

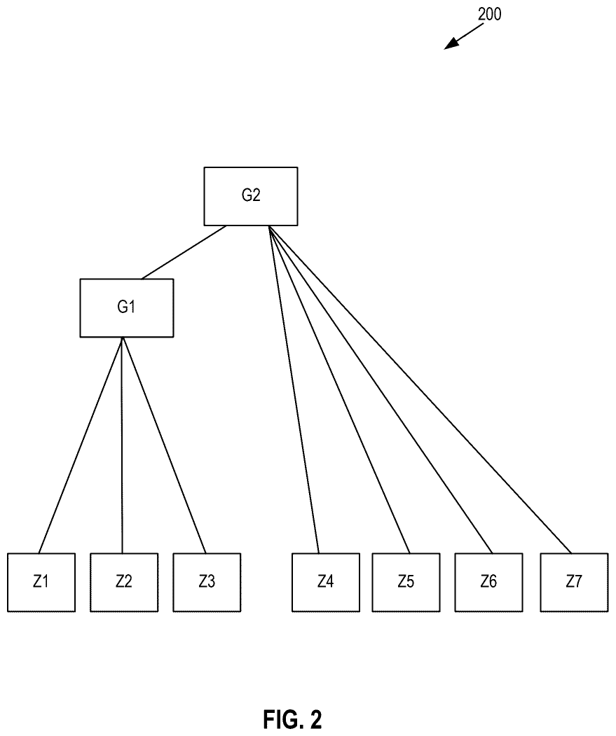

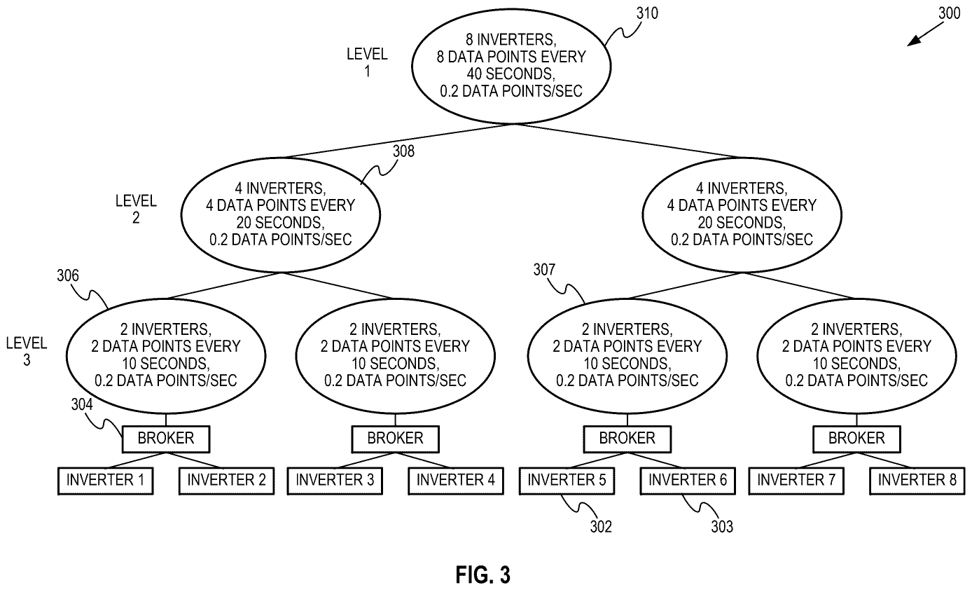

FIG. 2 is an example tree structure for controlling the seven zones shown in FIG. 1. Each leaf (e.g., Z1) represents the controls within a subregion of a distribution network, while internal nodes (e.g., G1) represent controls over larger regions created by combining any number of smaller regions. These nested controls form tree structure 200, where controls that cover wide areas (and thus a greater number of DERs) typically require coarser information from DERs (not shown in FIG. 2). As shown in FIG. 3, DERs reside in the smallest regions to which they belong. FIG. 3 is an example of controls and the type of data that DERs use to form a tree according to various embodiments of the present disclosure. As depicted, tree 300 comprises inverters (e.g., 302), message brokers (e.g., 304) come on end levels of control 306-310. The leaves of tree 300 represent the DERs that generate data to be monitored and controlled. Each internal node (e.g., 307) represents a control unit and a set of data useful for grid control. As depicted, each control unit collects data from the DERs below as time series data. For example, internal node 307 collect data from inverter 302 and 303. In this example in FIG. 3, each of the inverters generates new data every 10 seconds.

A major objective is to compute (or update) all the time series needed for controls as efficiently as possible, while minimizing resource usage. This is challenging due to the large number of inverters, which may be widely spread in a geographic area. In embodiment, the following properties are set for the tree data structure of controls: A set of time series are organized in a hierarchical manner (the shape of tree) with the following properties: (1) leaves of tree 300 correspond to set of time series data of DERs in the smallest sub-regions; (2) internal nodes (e.g., 307) of tree 300 represent aggregated time series data from DERs in the all the sub-regions corresponding to their child leaves; and (3) the time resolution of the time series in any node is never higher than that of any of its children. For example, in some embodiment, the resolution of the time series data in any node may be a multiple of the resolution of its children's time series data. This rule facilitates the generation of time series data from the data in its child nodes. It is noted that in balanced tree 300, the data rate at each node is constant (here, 0.2 data points/sec). Advantageously, this allows each node to operate using the same processing capabilities.

As a result, embodiments herein can gather data from a very large number (at least 100,000) of DERs and organize it into multiple time series data sets needed for grid control, which previously has not been possible. Certain embodiments substantially raise the threshold of DER integration limits compared to existing systems. In theory, these embodiments can scale to 1,000,000 or more DERs.

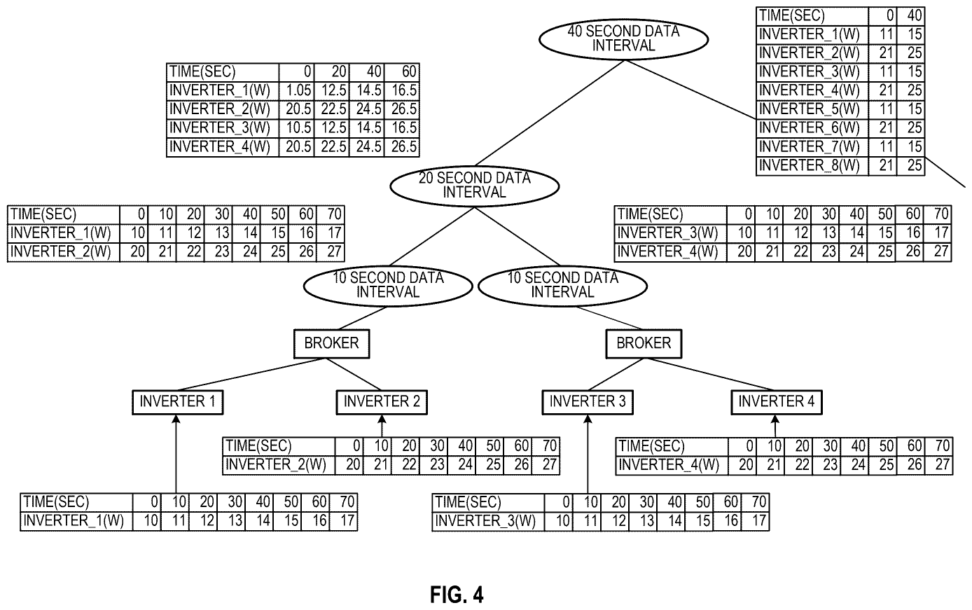

FIG. 4 is an example of a control tree and the sample time series data each node collects according to various embodiments of the present disclosure. Components similar to those in FIG. 3 are numbered similarly and the numeric examples mirror those in FIG. 3. It is noted that while the data in an internal node can be derived from the data in the leaves, in embodiment, it is faster to generate this data using the data in child nodes by taking advantage of the rule that the time series resolution at a node is a multiple of that of its children's nodes. As shown in FIG. 4, power data, measured in Watt, and gathered at the leaves in 10 second intervals at level 3 306. At level 2 308, data from level 3 306 is sampled and computed at 20 second intervals and, at level 1 310, data from level 2 308 is sampled and computed at 40 second intervals.

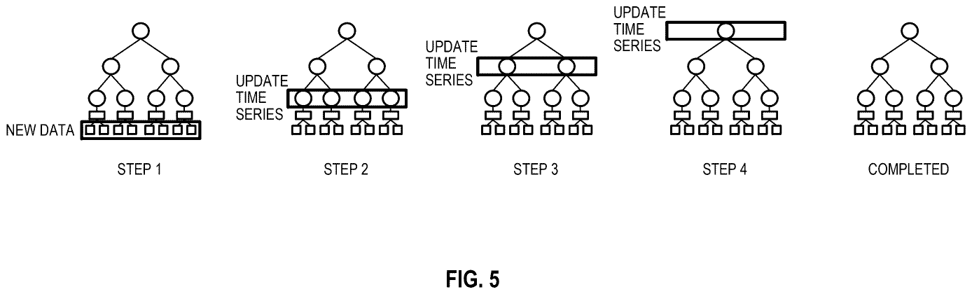

FIG. 5 illustrates how a naïve method computes controls for a well-balanced tree, potentially using multiple processors according to various embodiments of the present disclosure. In embodiments, each of the seven nodes may be assigned a CPU. Once data in one level is available, the next higher level in the tree may commence its calculations. At step 1 in FIG. 5, new data is generated at the leave (DER) level. At step 2, the time series data at the level above the leaves are updated. These updates can occur in parallel across nodes at the same level if multiple processors are used. In FIG. 5 nodes whose time series have been updated are shown in gray for all subsequent steps. At step 3 and beyond, updates proceed on the lowest node that has not yet been updated, using the time series data from child nodes of that lowest node in the tree. The process is repeated until the root node has been updated. The total parallel steps for such a process is O(height of the tree).

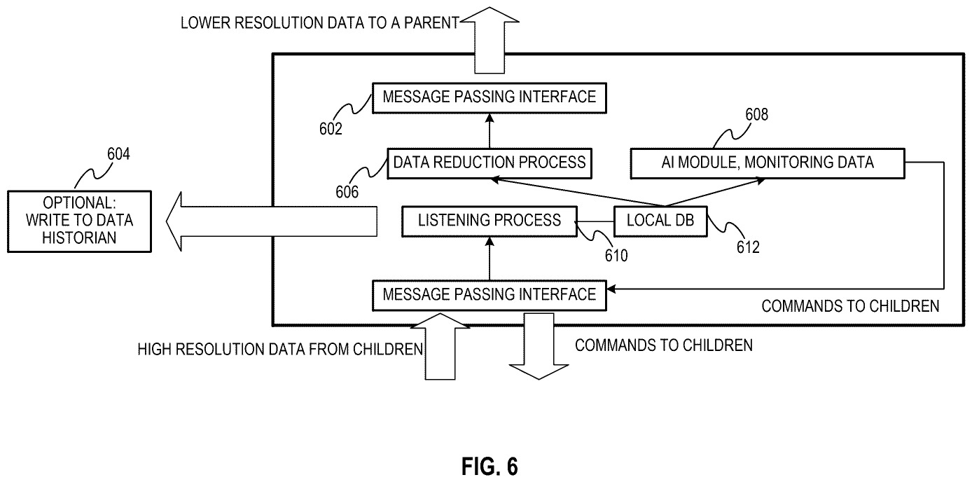

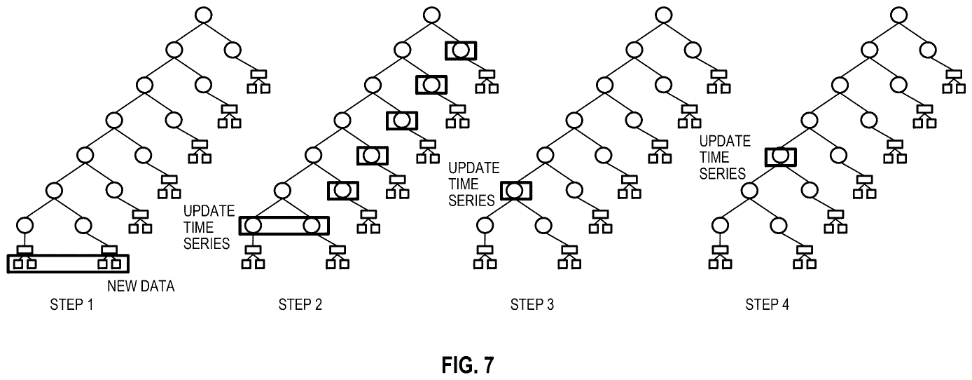

FIG. 6 illustrates how a control tree node computes a set of time series data from DERs according to various embodiments of the present disclosure. Listening process 610 receives high-resolution time series data from its children via Message Passing Interface (MPI) 602 and stores this data in local database 612 for further analysis. Data historian 604 is a scalable database with high throughput but high latency, used for subsequent global data analysis. The time series data saved at local database is read by data reduction process 606, which converts it to a coarser resolution needed by the parent node, e.g., by combining data from two or more nodes, and sends this reduced data to the parent node via MPI.

Let n be the number of nodes in the tree. The naïve algorithm computes all the time series in O(height of the tree) steps, which is efficient when the tree is balanced.

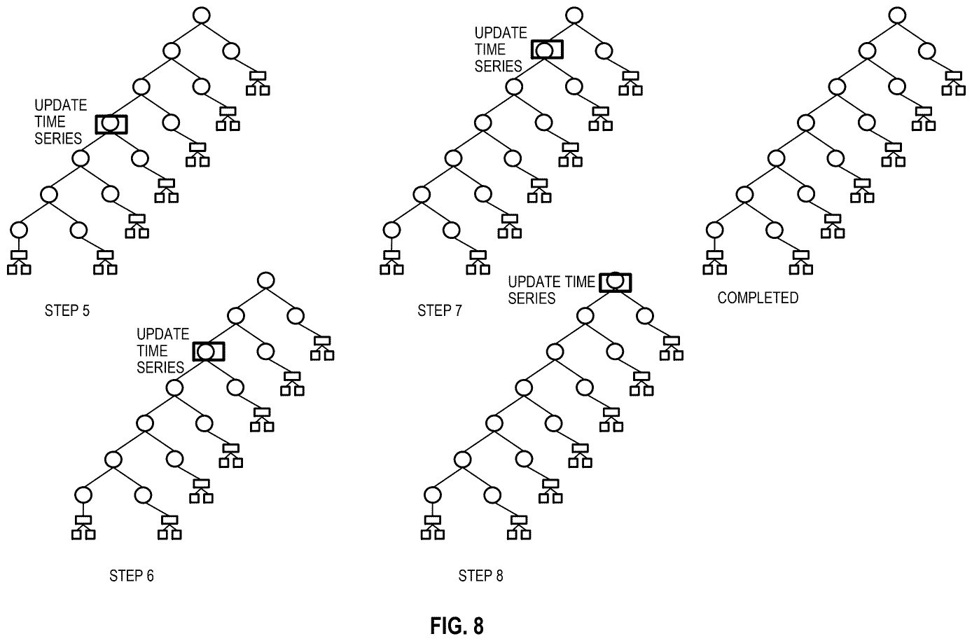

However, when the tree is unbalanced, the height of tree can be O(number of nodes). In such cases, the run time of O(height of the tree) is equal to O(n) using n processors, which is inefficient as it equates to the run time of using only one processor. [symbol] and FIG. 8 illustrate a naïve update for unbalanced trees, according to various embodiments of the present disclosure. The linear processing of such a naïve algorithm typically results in poor performance and a run time of O(n), even when n processors are used.

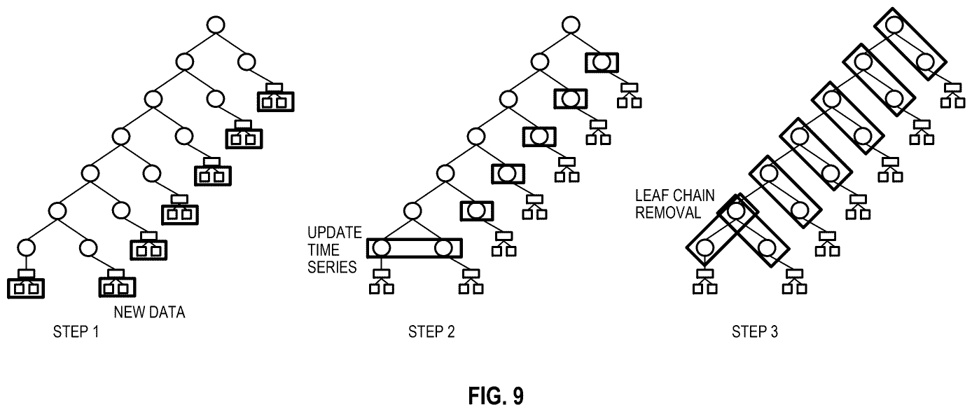

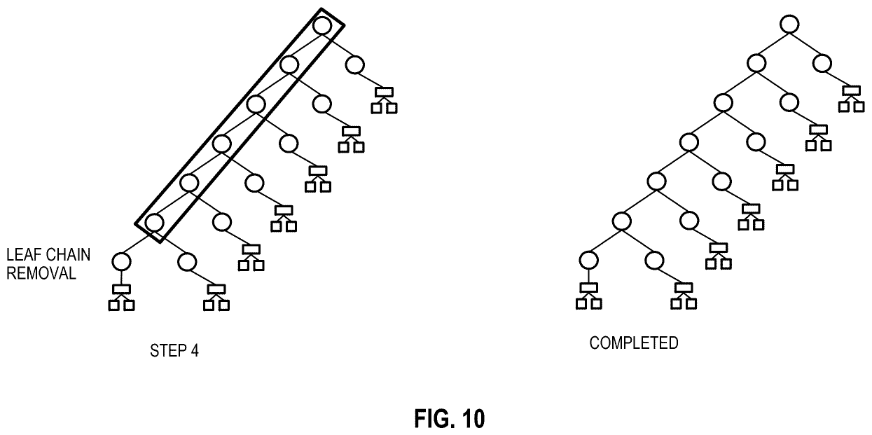

In embodiments, applying a parallel tree accumulation algorithm significantly improves the worst-case execution speed. FIG. 9 and FIG. 10 illustrate details of parallel tree accumulation algorithm's operation on an unbalanced tree according to various embodiments of the present disclosure. The members of each leaf chains in FIG. 9 and FIG. 10 are indicated by rectangular boxes. As shown, in embodiments, the truncated leaf chains are successively removed or collapsed by using segmented parallel prefix operations. Advantageously, unlike the naïve method, this process results in a run time of O(log(n)*time_for_parallel_prefix) regardless of tree height.

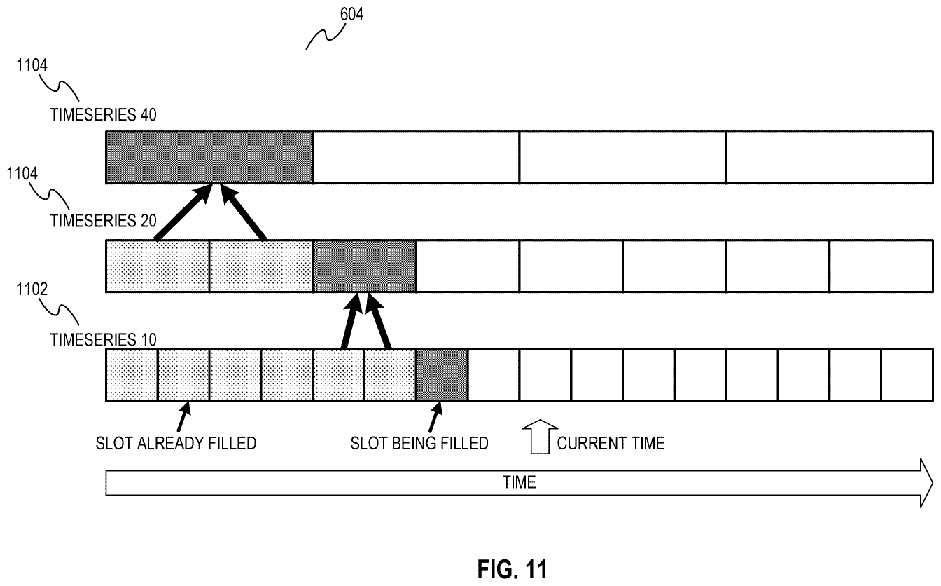

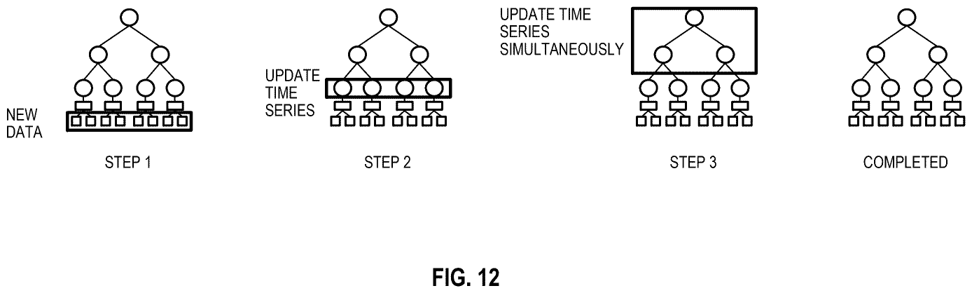

In addition, in embodiments, the computation of the control tree can be further improved by introducing the following rule: At any timestep, update one step older entries in the time series. This rule enables simultaneous updates of time series data in a single parallel step. [symbol] illustrates how to update multiple interdependent time series simultaneously, according to various embodiments of the present disclosure. As depicted, time series data 1102, 1104, and 1106 from the same set of DERs are updated at different time resolutions, here, 10, 20, and 40-second intervals. The x-axis in FIG. 11 represents time, and each box symbolizes a data slot within the time series that each corresponds to a timestamp. At the timestep indicated by the “Current time” arrow, for each set of time series data 1102, 1104, and 1106, the dark gray time series slots are computed using data from the time series slots denoted as “Slot already filled.” In this way, the “update the one slot older than the current slot” rule allows all time series slots being simultaneously updated with existing and available data. FIG. 12 illustrates how nodes in the tree are updated using this “update the one slot older” rule according to various embodiments of the present disclosure. As depicted, the entire process is completed in three parallel steps, regardless of the number of nodes or tree depth. It is noted that the trade-off for gaining computational efficiency in this manner is that the most recent time series entry will not be immediately accessible, thus introducing a slight delay in the data gathering process.

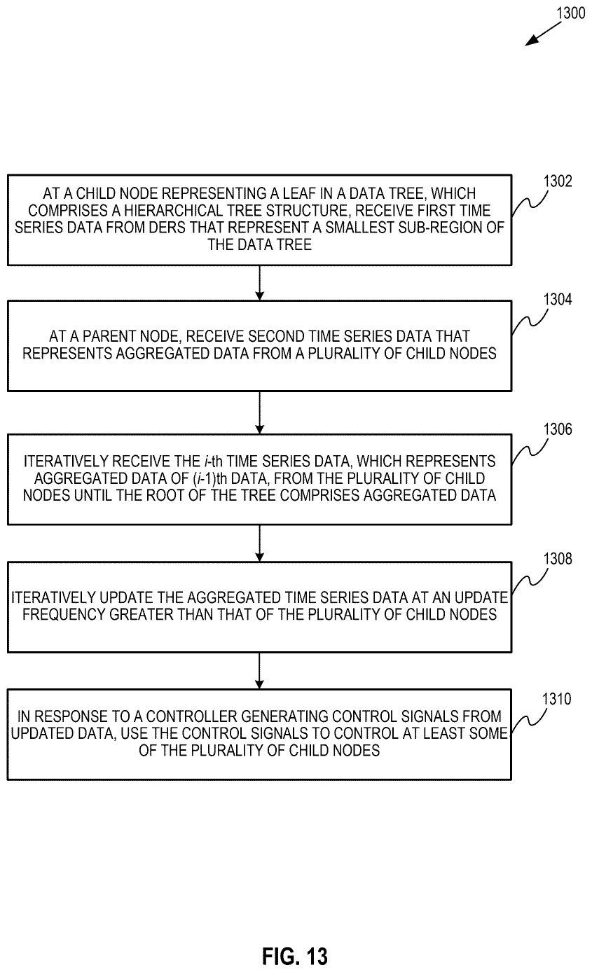

FIG. 13 is a flowchart illustrating an exemplary process for scalable data gathering and grid control in accordance with various embodiments of the present disclosure. In embodiments, process 1300 may start at step 1302, when, at a child node that represents a leaf in a data tree, which comprises a hierarchical tree structure, first time series data is received from DERs that represent a smallest sub-region of the data tree.

At step 1304, at a parent node, second time series data that represents aggregated data from a plurality of child nodes is received.

At step 1306, iteratively, the i-th time series data, which represents aggregated data of (i−1)-th or less data, is received from a plurality of child nodes until the root of the tree comprises aggregated data at i, which represents the height of the tree.

At step 1308, the aggregated time series data are iteratively updated at an update frequency greater than that of the plurality of child nodes. Finally, at step 1310, in response to a controller generating control signals from updated data, the control signals may be used to control at least some of the plurality of child nodes.

One skilled in the art shall recognize that: (1) certain steps may optionally be performed; (2) steps may not be limited to the specific order set forth herein; (3) certain steps may be performed in different orders; and (4) certain steps may be done concurrently.

It is noted that although the invention is generally described in the context of control systems for power grids, it is understood that this is not intended to limit the scope of the present disclosure to such embodiments as the systems and methods for scalable data gathering and grid control described herein may be used in other control applications.

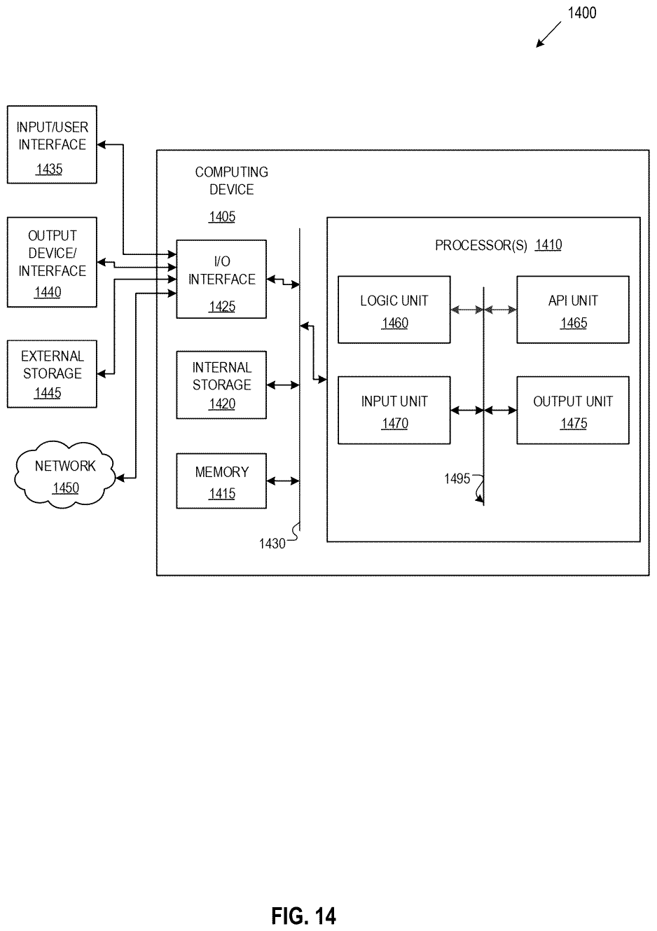

FIG. 14 illustrates an example computing environment with an example computer device according to various embodiments of the present disclosure. Computer device 1405 in computing environment 1400 can include one or more processing units, cores, or processors 1410, memory 1415 (e.g., RAM, ROM, and/or the like), internal storage 1420 (e.g., magnetic, optical, solid-state storage, and/or organic), and/or I/O interface 1425, any of which can be coupled on a communication mechanism or bus 1430 for communicating information or embedded in the computer device 1405. I/O interface 1425 is also configured to receive images from cameras or provide images to projectors or displays, depending on the desired implementation.

Computer device 1405 can be communicatively coupled to input/user interface 1435 and output device/interface 1440. Either one or both of input/user interface 1435 and output device/interface 1440 can be a wired or wireless interface and can be detachable. Input/user interface 1435 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1440 may include a display, television, monitor, printer, speaker, braille, or the like. In some example implementations, input/user interface 1435 and output device/interface 1440 can be embedded with or physically coupled to the computer device 1405. In other example implementations, other computer devices may function as or provide the functions of input/user interface 1435 and output device/interface 1440 for a computer device 1405.

Examples of computer device 1405 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1405 can be communicatively coupled (e.g., via I/O interface 1425) to external storage 1445 and network 1450 for communicating with any number of networked components, devices, and systems, including one or more computer devices of the same or different configurations. Computer device 1405 or any connected computer device can be functioning as, providing services of, or referred to as a server, client, thin server, general machine, special-purpose machine, or another label.

I/O interface 1425 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1400. Network 1450 can be any network or combination of networks (e.g., the Internet, local area network, wide area network, a telephonic network, a cellular network, a satellite network, and the like).

Computer device 1405 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1410 can execute under any operating system (OS) (not shown), in a native or virtual environment. One or more applications can be deployed that include logic unit 1460, application programming interface (API) unit 1465, input unit 1470, output unit 1475, and inter-unit communication mechanism 1495 for the different units to communicate with each other, with the OS, and with other applications (not shown). The described units and elements can be varied in design, function, configuration, or implementation and are not limited to the descriptions provided. Processor(s) 1410 can be in the form of hardware processors such as central processing units (CPUs) or a combination of hardware and software units.

In some example implementations, when information or an execution instruction is received by API unit 1465, it may be communicated to one or more other units (e.g., logic unit 1460, input unit 1470, output unit 1475). In some instances, logic unit 1460 may be configured to control the information flow among the units and direct the services provided by API unit 1465, input unit 1470, and output unit 1475, in some example implementations described above. For example, the flow of one or more processes or implementations may be controlled by logic unit 1460 alone or in conjunction with API unit 1465. The input unit 1470 may be configured to obtain input for the calculations described in the example implementations, and the output unit 1475 may be configured to provide output based on the calculations described in example implementations.

Processor(s) 1410 can be configured to execute a method or computer instructions which can involve receiving, at a child node that represents a leaf in a data tree, which includes a hierarchical tree structure, first time series data from DERs that represent a smallest sub-region of the data tree; receiving, at a parent node, second time series data that represents aggregated data from a plurality of child nodes; and iteratively, at nodes where all children nodes already have aggregated time series, further aggregated time series data is received from the plurality of child nodes, until all nodes in the tree have aggregated time series data; the aggregated time series data are iteratively updated at an update frequency greater than that the plurality of child nodes, as described, for example, with respect to FIG. 2.

Processor(s) 1410 can be configured to execute a method or computer instructions which can involve iteratively updating second time series data at an update frequency that is greater than that of the first time series data such that a time resolution of time series data at each node is not higher than that of its child nodes; and in response to a controller generating control signals from updated data, using the control signals to control at least some of the plurality of child nodes, as described, for example, with respect to FIG. 5 and FIG. 11.

The updating may exclude a latest received data to facilitate a network-wide data aggregation process, and cause a delay in data processing that eliminates a dependency in the network-wide data aggregation process, as described, for example, with respect to FIG. 12.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for scalable data gathering and grid control, the method comprising:
receiving, at a child node that represents a leaf in a data tree, which comprises a hierarchical tree structure, first time series data from distributed energy resources (DERs), the DERs representing a smallest sub-region of the data tree;
receiving, at a parent node, second time series data that represents aggregated data from a plurality of child nodes;
until a root of the data tree comprises aggregated data, iteratively receiving, at nodes where all children nodes already have aggregated time series, i-th time series data that represents aggregated data of (i−1)-th or less data from the plurality of child nodes;
iteratively updating the aggregated time series data at an update frequency that is greater than that of the plurality of child nodes; and
in response to a controller generating control signals from updated data, using the control signals to control at least some of the plurality of child nodes.

2. The method of claim 1, wherein the updating excludes a latest received data to facilitate a network-wide data aggregation process.

3. The method of claim 2, wherein the updating causes a delay in data processing that eliminates a dependency in the network-wide data aggregation process.

4. The method of claim 1, further comprising using a parallel tree accumulation process to increase a computation performance in an unbalanced tree structure.

5. The method of claim 4, wherein the parallel tree accumulation process reduces a worst-case execution speed regardless of a tree height.

6. The method of claim 1, wherein the controller, prior to receiving new data, analyzes first time series data and communicates the control signals to the DERs based on a predefined control rule.

7. The method of claim 1, wherein the time resolution of time series data at each node is equal or greater than the resolution of the time series data at its child nodes.

8. The method of claim 1, further comprising using a message passing to communicate time series data between nodes, the message passing using at least one of Message Passing Interface Chameleon, Open Message Passing Interface, or Parallel Virtual Machine.

9. The method of claim 1, wherein the data reduction process comprises child nodes converting time series data into lower-resolution data and sending the lower-resolution data to a parent node to reduce an amount of communicated data.

10. The method of claim 1, wherein the control signals are generated based on the updated time series data to mitigate at least one of an overvoltage, undervoltage, overfrequency, or underfrequency condition in a grid.

11. The method of claim 10, wherein the update frequency is adjusted based on a real-time operational requirement of the grid.

12. The method of claim 1, wherein each node comprises a processing unit that generates a control signal.

13. A non-transitory computer-readable medium for storing instructions for executing a process, the instructions comprising:
receiving, at a child node that represents a leaf in a data tree, which comprises a hierarchical tree structure, first time series data from distributed energy resources (DERs), the DERs representing a smallest sub-region of the data tree;
receiving, at a parent node, second time series data that represents aggregated data from a plurality of child nodes;
until a root of the data tree comprises aggregated data, iteratively receiving, at nodes where all children nodes already have aggregated time series, i-th time series data that represents aggregated data of (i−1)-th or less data from the plurality of child nodes;
iteratively updating the aggregated time series data at an update frequency that is greater than that of the plurality of child nodes; and
in response to a controller generating control signals from updated data, using the control signals to control at least some of the plurality of child nodes.

14. The non-transitory computer-readable medium of claim 13, wherein the updating excludes a latest received data to facilitate a network-wide data aggregation process, and wherein the time resolution of time series data at each node is equal or greater than the resolution of the time series data at its child nodes.

15. The non-transitory computer-readable medium of claim 14, wherein the updating causes a delay in data processing that eliminates a dependency in the network-wide data aggregation process.

16. The non-transitory computer-readable medium of claim 13, further comprising using a parallel tree accumulation process to increase a computation performance in an unbalanced tree structure, wherein the parallel tree accumulation process reduces a worst-case execution speed regardless of a tree height.

17. The non-transitory computer-readable medium of claim 13, wherein the controller, prior to receiving new data, analyzes first time series data and communicates the control signals to the DERs based on a predefined control rule.

18. The non-transitory computer-readable medium of claim 13, wherein the control signals are generated based on the updated time series data to mitigate at least one of an overvoltage, undervoltage, overfrequency, or underfrequency condition in a grid.

19. The non-transitory computer-readable medium of claim 18, wherein the update frequency is adjusted based on a real-time operational requirement of the grid.

20. The non-transitory computer-readable medium of claim 13, wherein each node comprises a processing unit that generates a control signal.
